(19) United States
(12) Patent Application Publication
(10) Pub. No.: US 2007/0233302 A1
(43) Pub. Date: Oct. 4, 2007

(54) System for controlling production of electronic devices, system and method for producing electronic devices, and computer program product

(76) Inventors: Kunihiro Miyazaki, Oita (JP); Yoshihiro Ogawa, Kanagawa (JP); Shoichi Harakawa, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/600,791

(22) Filed: Nov. 17, 2006

(30) Foreign Application Priority Data
Mar. 29, 2006 (JP) P2006-091940

(51) Int. Cl. G06F 19/00

(52) U.S. Cl. 700/108; 700/103

(57) ABSTRACT

A system for controlling production of electronic devices includes a recipe creation unit creating a processing recipe describing processing conditions for first and second processes so as to satisfy a production specification of a characteristic and a yield rate of the electronic devices, and an additional recipe describing additional processing conditions determined based on a relation of the characteristic and the yield rate to a latency time between a completion time of the first process and a start time of the second process so as to satisfy the production specification; and a recipe designation module designating the additional recipe for processing of intermediate products of the electronic devices, produced by the first process, when the latency time exceeds a reference.

### CROSS REFERENCE TO RELATED APPLICATIONS AND INCORPORATION BY REFERENCE

This application is based upon and claims the benefit of priority from prior Japanese Patent Application P2006-091940 filed on Mar. 29, 2006; the entire contents of which are incorporated by reference herein.

### BACKGROUND OF THE INVENTION

1. Field of the Invention

The present invention relates to the manufacture of an electronic device, and more particularly relates to a production system for performing processes by controlling a latency time between the processes, and a method for manufacturing an electronic device.

2. Description of the Related Art

Generally, in facilities for manufacturing an electronic device, such as a semiconductor device, a liquid crystal display (LCD) and the like, a plurality of substrates, stored in a container, are transferred to a plurality of manufacturing apparatuses. The plurality of substrates are processed based on the same manufacturing specification. The plurality of substrates stored in the container are collectively referred to as a lot for a manufacturing unit.

For example, when semiconductor devices are manufactured, it is ideal to process each lot from one manufacturing process to the next manufacturing process without any time delay, such as a wait time. However, a latency time between processes actually occurs due to a transfer time of the lot, an elapsed preparation time from taking out the semiconductor substrates in the container before starting a manufacturing process, a down time due to problems and maintenance of the manufacturing apparatus, and the like. Also, in typical facilities for manufacturing the semiconductor device, since a wide variety of semiconductor devices are manufactured, a wait time caused by an interrupt of the lot processing occurs. The time delay between the manufacturing processes increases manufacturing time, and decreases production efficiency.

In order to improve the production efficiency, production control methods for minimizing a latency time between manufacturing processes have been proposed (refer to Japanese Laid Open No. 2004-153191 and Japanese Laid Open No. 2003-330524). In the proposed production control methods, countermeasures for minimizing a latency time include selecting a manufacturing apparatus based on a quality performance and an execution status of the manufacturing apparatus, or changing a sequence of the manufacturing processes.

For example, in a dry etching process, reacted gases of the dry etching are adsorbed on a surface of a semiconductor substrate. The semiconductor substrate is transferred to a wet process, which is for a post-processing of the dry etching, with the adsorbed reacted gases. If a latency time between the dry etching process and the wet process increases, the composition of the adsorbed reacted gases may change during the latency time. Therefore, it may be difficult to remove the adsorbates by the wet process. As a result, a characteristic of the manufactured semiconductor device may deteriorate.

Moreover, there is a case in which the wet process, after the dry etching process, also serves as a pre-processing of a deposition process, such as sputtering, chemical vapor deposition (CVD) and the like, which is subsequently carried out. If the latency time between the wet process and the deposition process increases, growth of a native oxide film, or adsorption of a minute amount of organic matter, from inside a clean room for semiconductor manufacture, can occur on the surface of the semiconductor substrate. A change of the surface state of the semiconductor substrate has an influence on the characteristic of the semiconductor device.

Put simply, even in the time between the manufacturing processes, physical chemical reaction, physical adsorption and the like may slightly occur on the surface of the semiconductor substrate, to have an influence on the characteristic of the semiconductor device. In particular, as the semiconductor device becomes finer, the influence of the slight physical chemical reaction and physical adsorption become more sever.

In order to prevent the deterioration of the quality of the semiconductor device, a method for controlling a permissible time with respect to a latency time between manufacturing processes has been proposed (refer to Japanese Laid Open No 2001-351964). Here, first and second processes are assumed as an example of the manufacturing processes. In order for the latency time between the first and second processes to be within the permissible time, the lot is transferred at the proper time when both manufacturing apparatuses used for the first and second processes are available.

However, unless both of the manufacturing apparatuses are available, a wasted latency time occurs before the first process. Alternatively, if a sudden malfunction occurs in the manufacturing apparatus of the second process during processing of the first process, a latency time occurs after completion of the first process. If the long wait time causes the second process to be started after the permissible time has elapsed, the characteristics of the semiconductor devices manufactured in the lot are deteriorated. Alternatively, at the time when the latency time exceeds the permissible time, manufacturing of the lot is abandoned. Thus, the manufacturing yield of the semiconductor devices is decreased.

Moreover, even if the time delay between the manufacturing processes is within a permissible limit, physical chemical reaction, physical adsorption and the like occurs with time on the surface of the semiconductor substrate, even within the permissible time, to have an influence on the characteristic of the semiconductor device. Thus, even if the permissible time is controlled, an essential solution may not be achieved.

### SUMMARY OF THE INVENTION

A first aspect of the present invention inheres in a system for controlling production of electronic devices including a recipe creation unit configured to create a processing recipe and an additional recipe, the processing recipe describing processing conditions for first and second processes so as to satisfy a production specification of a characteristic and a yield rate of the electronic devices, the first process executed in a first manufacturing apparatus and the second process executed in a second manufacturing apparatus after the first process, the additional recipe describing additional processing conditions determined based on a relation of the characteristic and the yield rate to a latency time between a completion time of the first process and a start time of the second process so as to satisfy the production specification; and a recipe designation module configured to designate the additional recipe for processing of intermediate products for the electronic devices, the intermediate products are produced by the first process, when the latency time exceeds a reference.

A second aspect of the present invention inheres in a system for producing electronic devices including a first manufacturing apparatus configured to execute a first process; a second manufacturing apparatus scheduled to execute a second process after the first process; a recipe creation unit configured to create a processing recipe and an additional recipe, the processing recipe describing processing conditions for the first and second processes so as to satisfy a production specification of a characteristic and a yield rate of the electronic devices, the additional recipe describing additional processing conditions determined based on a relation of the characteristic and the yield rate to a latency time between a completion time of the first process and a start time of the second process so as to satisfy the production specification; and a recipe designation module configured to designate the additional recipe for processing of intermediate products for the electronic devices, the intermediate products are produced by the first process, when the latency time exceeds a reference.

A third aspect of the present invention inheres in a method for producing electronic devices including producing intermediate products for the electronic devices by processing with a first manufacturing apparatus based on a first processing recipe, the first processing recipe describing a first processing condition for a first process so as to satisfy a production specification of a characteristic and a yield rate of the electronic devices; transferring the intermediate products to a second manufacturing apparatus in which a second process is scheduled to be executed after the first process; acquiring the additional recipe when the latency time exceeds a reference, the additional recipe describing an additional processing condition determined based on a relation of the characteristic and the yield rate to a latency time between a completion time of the first process and a start time of the second process so as to satisfy the production specification; and processing the intermediate products based on the additional recipe and a second processing recipe, the second processing recipe describing a second processing condition for the second process so as to satisfy the production specification of the characteristic and the yield rate of the electronic devices.

A fourth aspect of the present invention inheres in a computer program product configured to be executed by a computer including an instruction to create first processing, second processing and an additional recipes, the first and second processing recipes describing processing conditions for first and second processes so as to satisfy a production specification of a characteristic and a yield rate of the electronic devices, the second process executed after the first process, the additional recipe describing additional processing conditions determined based on a relation of the characteristic and the yield rate to a latency time between a completion time of the first process and a start time of the second process so as to satisfy the production specification; an instruction to drive the first manufacturing apparatus so as to produce intermediate products for the electronic devices by processing with the first manufacturing apparatus based on the first processing recipe; an instruction to drive the transfer system so as to transfer the intermediate products to the second manufacturing apparatus; an instruction to acquire the additional recipe when the latency time exceeds a reference; and an instruction to drive the second manufacturing apparatus so as to process the intermediate products based on the additional recipe and the second processing recipe.

### BRIEF DESCRIPTION OF THE DRAWINGS

FIG. 1 is a schematic view showing an example of a configuration of a production system according to an embodiment of the present invention;

FIG. 2 is a view showing an example of a process flow for a semiconductor device, used for explaining the embodiment of the present invention;

FIG. 3 is a view showing an example of a relation between the yield rate and the latency time of the semiconductor device of the comparative example;

FIG. 4 is a view showing another example of a relation between the yield rate and the latency time of the semiconductor device of the comparative example;

FIG. 5 is a view showing an example of a relation between the yield rate and the latency time of the semiconductor device manufactured by the production system according to the embodiment of the present invention;

FIG. 6 is a view showing another example of a relation between the yield rate and the latency time of the semiconductor device manufactured by the production system according to the embodiment of the present invention;

FIG. 7 is a flowchart showing an example of the method for manufacturing the semiconductor device according to the embodiment of the present invention; and

FIG. 8 is a schematic view showing an example of a configuration of a production system according to a modification of the embodiment of the present invention.

### DETAILED DESCRIPTION OF THE INVENTION

Various embodiments of the present invention will be described with reference to the accompanying drawings. It is to be noted that the same or similar reference numerals are applied to the same or similar parts and elements throughout the drawings, and the description of the same or similar parts and elements will be omitted or simplified.

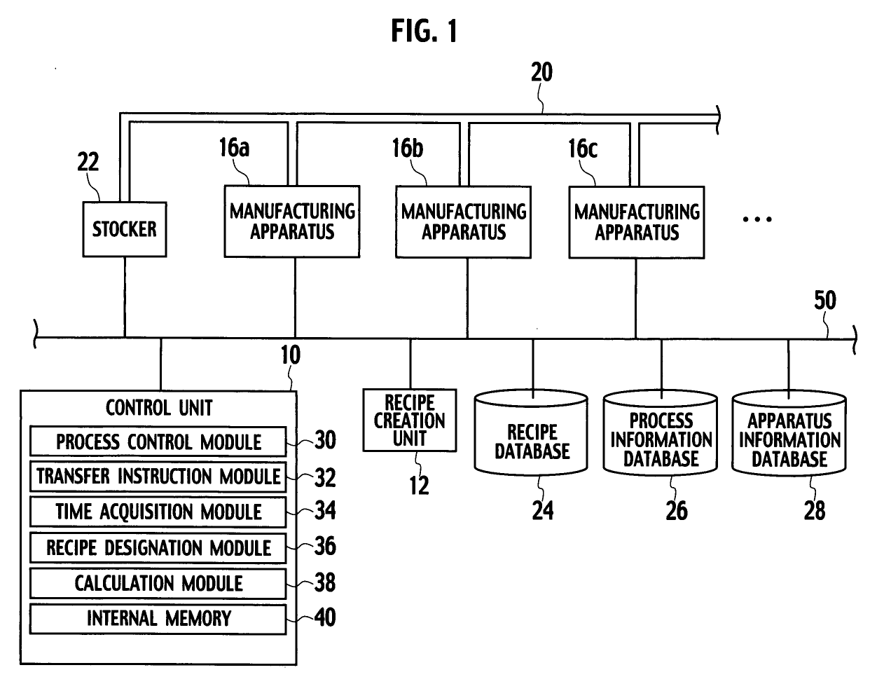

A system for producing an electronic device according to an embodiment of the present invention includes a control unit 10, a recipe creation unit 12, a plurality of manufacturing apparatuses 16a, 16b, 16c, . . . , a transfer system 20, a stocker 22, a recipe database 24, a process information database 26, an apparatus information database 28 and the like, as shown in FIG. 1. Also, the control unit 10 includes a process control module 30, a transfer instruction module 32, a time acquisition module 34, a recipe designation module 36, a calculation module 38, and an internal memory 40 and the like.

The transfer system 20 is installed between the manufacturing apparatuses 16a, 16b, 16c, . . . and the stocker 22. The control unit 10, the recipe creation unit 12, the plurality of manufacturing apparatuses 16a, 16b, 16c, . . . , the stocker 22, the recipe database 24, the process information database 26, the apparatus information database 28 and the like are connected through a communication line 50, such as a local area network (LAN) and the like.

The control unit 10 drives the manufacturing apparatuses 16a, 16b, 16c, . . . , and the transfer system 20 so as to produce the electronic device.

The control unit 10 and the recipe creation unit 12 may be part of a central processing unit (CPU) of a general purpose computer system. The process control module 30, the transfer instruction module 32, the time acquisition module 34, the recipe designation module 36 and the calculation module 38 may be discrete hardware, or may be provided by virtually equivalent functions achieved by software, using the CPU of the general purpose computer system.

The manufacturing apparatuses 16a, 16b, 16c, . . . are used to manufacture the electronic device, such as a semiconductor device, in accordance with a previously designed process flow. The manufacturing apparatuses 16a, 16b, 16c, . . . include, for example, a dry etching apparatus, such as a reaction ion etching (RIE) apparatus, a wet processing apparatus, a CVD apparatus, an evaporation apparatus, an ion implantation apparatus, a photolithography system and the like.

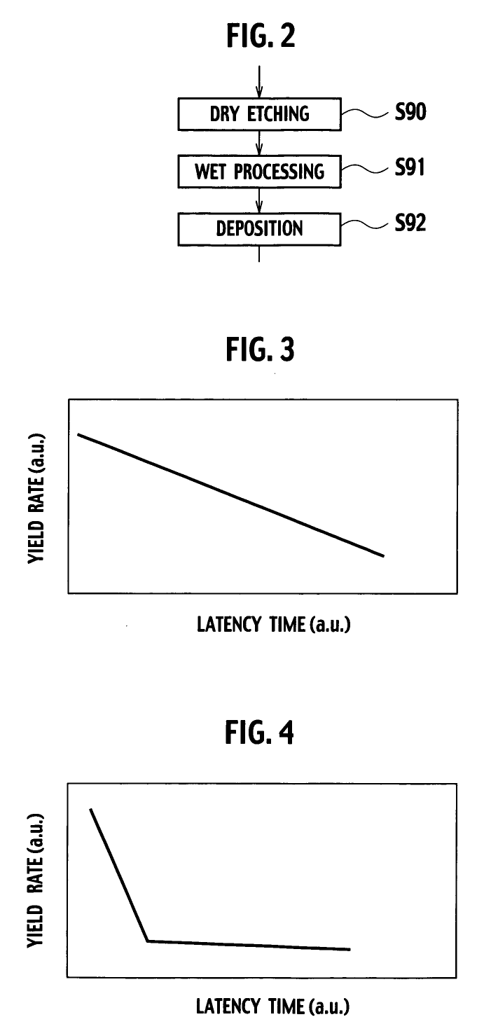

For example, as shown in FIG. 2, in Step S90, an insulating film on a surface of a semiconductor substrate, such as a silicon (Si) substrate, is selectively removed by dry etching, such as RIE, using a dry etching apparatus so as to produce an intermediate product for the electronic device. At Step S91, impurities and reaction by-products and the like, which are deposited on the surface of the substrate, or the intermediate product for the electronic device, by dry etching, are removed by wet processing using the wet processing apparatus. At Step S92, a conductive material, such as polycrystalline Si (poly Si), is deposited on the wet-processed surface of the substrate (intermediate product) by a deposition process, such as CVD, using a CVD apparatus, to form wiring layouts.

The recipe creation unit 12 creates a processing recipe in which processing conditions are described for a process to be executed by a manufacturing apparatus used for manufacturing the semiconductor device. Typically, each processing recipe for the process, such as dry etching, wet processing, deposition and the like, is created by experimentally executing and evaluating the process in advance and determining the processing conditions which satisfy a production specification of the semiconductor device, before the semiconductor device is produced. The created processing recipe is stored in the recipe database 24.

For example, in the dry etching process, processing conditions, such as the kind of gas, an etching time, the plasma power, a processing sequence and the like, are determined so as to satisfy the production specification of a wiring width, an etching depth and the like. In the wet process, which is executed as the post-processing of the dry etching, processing conditions, such as the kind of chemical agent, the temperature, a processing time, a processing sequence and the like, are determined so as to remove impurities, reaction by-products and the like, which are adhered by dry etching, from the surface of the substrate processed by the processing conditions of the dry etching process. Also, in the deposition process, processing conditions, such as the kind of gas, a deposition time, the deposition temperature, a processing sequence and the like, are determined so as to satisfy the production specification of wiring thickness and the like.

In the processing recipe created as mentioned above, a latency time that occurs in the production is not considered. For example, composition of the reacted gas adsorbed on the surface of the substrate in the dry etching process changes with time before starting the wet process. As a result, as shown in FIG. 3, the yield rate of the semiconductor device is gradually decreased with increase of the latency time between the dry etching process and the wet process. Also, on the surface of the substrate processed by wet processing, a rapid change with time occurs due to growth of a native oxide film, adsorption of organic matter from the atmosphere, and the like. As a result, as shown in FIG. 4, the yield rate of the semiconductor device is rapidly decreased, depending on the latency time between the wet process and the deposition process.

The recipe creation unit 12 creates an additional recipe in which additional processing conditions to be determined by the relation between the latency time and the characteristic and the yield rate of the semiconductor device are described, so as to satisfy the production specification of the characteristic and the yield rate of the semiconductor device. The created additional recipe is stored in the recipe database 24.

The term “additional processing conditions to satisfy the production specification of the semiconductor device” refers to the additional processing conditions with which, for example, the materials, due to physical chemical reaction with time within the time from the completion time of the dry etching process to the start time of the wet process, can be removed. The recipe creation unit 12 creates the additional recipe in which the determined additional processing conditions are described. The additional processing is executed by the wet processing apparatus, for example, before or after the wet process. In addition, the additional recipe may include a modification of a processing temperature, a processing time, the kind of chemical agent, a concentration of a chemical agent, or the like in the wet processing. Also, the addition processing may be executed by a processing apparatus different from the wet processing apparatus executing the wet processing.

Furthermore, the additional processing conditions are determined with respect to the materials formed, on the surface of the substrate, by the temporal chemical reaction, the physical adsorption, and the like, so that such materials can be removed within a time from the completion time of the wet process to the start time of the deposition process. The recipe creation unit 12 creates the additional recipe in which the determined additional processing conditions are described. The addition processing is executed before the deposition process, for example, by a processing apparatus different from the deposition apparatus.

The process control module 30 of the control unit 10 controls the process flow for manufacturing the semiconductor device of each lot by referring to the design specification of the process flow and the process history of each lot stored in the process information database 26. For a target lot, for example, when processing of a first process is finished in the manufacturing apparatus 16a (first manufacturing apparatus), the manufacturing apparatus 16a transmits information of completion of the first process to the control unit 10. The process control module 30 determines a second process to be executed after the first process, based on the process flow. Also, the process control module 30 records the completion of the first process of the target lot to update the process history.

The transfer instruction module 32 instructs the transfer system 20 to transfer the target lot between the manufacturing apparatuses 16a, 16b, 16c, . . . , by referring to each execution status of the manufacturing apparatuses 16a, 16b, 16c, . . . stored in the apparatus information database 28. For example, the execution status of the manufacturing apparatus 16b (second manufacturing apparatus) that is scheduled to execute processing of a target second process is examined. If processing of the second process is possible, the transfer system 20 is instructed to transfer the target lot to the manufacturing apparatus 16b from the manufacturing apparatus 16a in which the first process has been finished. If the manufacturing apparatus 16b is at work on a different lot or is shutdown due to maintenance or failure, the transfer instruction module 32 instructs the transfer system 20 to wait in front of the manufacturing apparatus 16b and retain the target lot. The waiting location of the target lot may also be inside the stocker 22 where the atmosphere, such as temperature, humidity and the like, are controlled, or on the transfer system 20. When the target lot is waiting inside the stocker 22, the transfer instruction module 32 instructs the transfer system 20 to transfer the target lot to the stocker 22.

The time acquisition module 34 acquires a completion time of each process processed by the manufacturing apparatuses 16a, 16b, 16c, . . . , and an arrival time of each lot, from each of the manufacturing apparatuses 16a, 16b, 16c, . . . For example, the time when the target lot is unloaded from a processing chamber of the manufacturing apparatus 16a is acquired from the manufacturing apparatus 16a as the completion time of the first process. Also, the time when the target lot loaded to a load port of the manufacturing apparatus 16b is acquired from the manufacturing apparatus 16b as the start time of the second process. In addition, when the first process is processing of single wafer processing, the completion time is acquired every time each substrate of the target lot has completed processing. Also, when the time delay of processing between the first substrate and the last substrate in the target lot is not so long as to deteriorate the characteristic or the yield rate of the semiconductor device, the completion time for processing of all substrates may be acquired.

The recipe designation module 36 designates a processing recipe of each process of the manufacturing apparatuses 16a, 16b, 16c, . . . , to the manufacturing apparatuses 16a, 16b, 16c, . . . For example, when the arrival time of the target lot is sent from the manufacturing apparatus 16b, the processing recipe of the second process is designated to the manufacturing apparatus 16b. The manufacturing apparatus 16b acquires the designated processing recipe from the recipe database 24.

The calculation module 38 calculates a latency time between the completion time of each process processed by the manufacturing apparatuses 16a, 16b, 16c, . . . and the start time of the next process. Here, it is assumed that the second process is executed after the first process. The latency time between the completion time of the first process and the start time of the second process is calculated. If the calculated latency time exceeds a predetermined reference, the recipe designation module 36 designates the corresponding additional recipe to the manufacturing apparatus 16b. As the reference, for example, a time that is shorter than a latency time, so as to ensure the production specification of the yield rate of the semiconductor device, is used. The manufacturing apparatus 16b acquires the designated additional recipe from the recipe database 24.

The internal memory 40 temporarily stores data obtained during processing or a calculation, during the operation of the control unit 10.

A latency time dependence of the yield rate of the semiconductor device manufactured by the production system, according to the embodiment of the present invention, is evaluated together with a comparative example manufactured by using only the processing recipe. For example, the semiconductor devices are manufactured by individually varying latency times between the dry etching process and the wet process and between the wet process and the deposition process, in the process flow shown in FIG. 2.

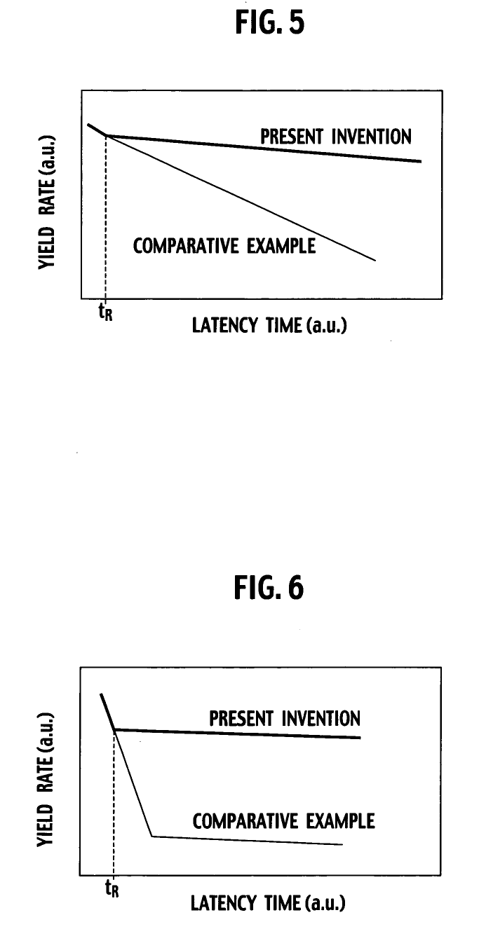

In the embodiment of the present invention, when the latency time exceeds a reference t_{R}, processing based on the additional recipe is added to remove the materials formed by the physical chemical reaction over time and the physical adsorption. As a result, as shown in FIGS. 5, 6, even when the latency time between the dry etching process and the wet process and the latency time between the wet process and the deposition process exceed the reference t_{R}, a decrease of the yield rate is suppressed. On the other hand, in the comparative example, the yield rate is decreased with an increase of the latency time.

In the production system according to the embodiment of the present invention, when the first process and the second process scheduled to be executed after the first process are used as an example, the additional recipe of the processing conditions to remove the reaction by-products formed by the chemical reaction and the adsorbates formed by the physical adsorption on the surface of the substrate during the latency time between the completion time of the first process and the start time of the second process is designated to the second process. Thus, it is possible to manufacture the semiconductor device while suppressing the deterioration of the characteristic and the decrease of the yield rate.

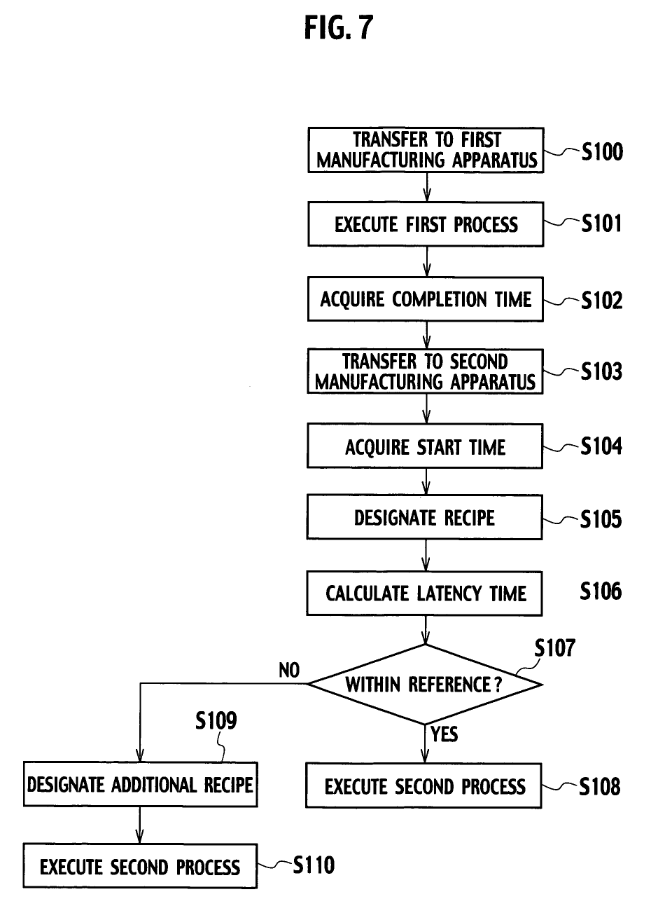

A method for manufacturing a semiconductor device, according to the embodiment of the present invention, will be described with the flowchart shown in FIG. 7. For example, in the first process and the second process scheduled to be executed after the first process, processing recipes are created before the semiconductor device is manufactured, so the processing conditions satisfy the production specification of the characteristic and yield rate of the semiconductor device for the first process executed in the first manufacturing apparatus and the second process executed in the second manufacturing apparatus. Also, additional recipes are created, in which additional processing conditions satisfy the production specification based on the relation of the characteristic and yield rate of the semiconductor device to the latency time between the completion time of the first process and the start time of the second process. The processing recipes and the additional recipes are stored in the recipe database 24.

In Step S100, the process control module 30 of the control unit 10 determines the first process to be executed to the target lot by referring to the process flow and the process history, which are stored in the process information database 26. In accordance with an instruction from the transfer instruction module 32, the transfer system 20 transfers the target lot to the first manufacturing apparatus. When the time acquisition module 34 acquires the start time from the first manufacturing apparatus, the recipe designation module 36 designates the processing recipe of the first process to the first manufacturing apparatus. The first manufacturing apparatus acquires the processing recipe of the first process from the recipe database 24.

In Step S101, each substrate of the target lot is processed using the first manufacturing apparatus based on the processing recipe of the first process so as to produce an intermediate product of the electronic device. When the processing of the first process of the target lot is completed, the first manufacturing apparatus transmits the completion time to the control unit 10.

In Step S102, the time acquisition module 34 acquires the completion time of the first process. When the completion time is acquired, the process control module 30 determines the second process to be executed to the target lot as the next process of the first process by referring to the process flow.

In Step S103, the transfer instruction module 32 examines the execution status of the second manufacturing apparatus, which is stored in the apparatus information database 28. When the second manufacturing apparatus is usable, in accordance with instruction of the transfer instruction module 32, the transfer system 20 transfers the target lot from the first manufacturing apparatus to the second manufacturing apparatus. When the second manufacturing apparatus is unusable, instructions are given to hold the target lot to wait in the stocker 22 or in front of the first manufacturing apparatus, until the second manufacturing apparatus becomes usable. When the lot arrives at the load port of the second manufacturing apparatus, the start time is transmitted to the control unit 10.

In Step S104, the time acquisition module 34 acquires the start time transmitted by the second manufacturing apparatus.

In Step S105, the recipe designation module 36 designates the processing recipe of the second process to the second manufacturing apparatus. The second manufacturing apparatus acquires the processing recipe of the second process from the recipe database 24.

In Step S106, the calculation module calculates the latency time between the completion time of the first process and the start time of the second process. In Step S107, the calculated latency time is compared with the reference.

When the calculated latency time is within the reference, in Step S108, in accordance with the processing recipe of the second process, the target lot is processed by the second manufacturing apparatus.

When the calculated latency time is equal to or longer than the reference, in Step S109, the recipe designation module 36 designates the additional recipe to the second manufacturing apparatus, based on the calculated latency time. The second manufacturing apparatus acquires the additional recipe of the second process from the recipe database 24.

In Step S110, in accordance with the additional recipe and processing recipe of the second process, the target lot is processed.

In the method for manufacturing the semiconductor device according to the embodiment of the present invention, based on the latency time between the completion time of the first process and the start time of the second process, the additional recipe of the additional processing conditions is designated to the second process to satisfy the production specification of the characteristic and the yield rate of the semiconductor device. The additional processing conditions are conditions in which the reaction by-products formed by the physical chemical reaction over time and the adsorbates by physical adsorption in the latency time can be removed. Thus, it is possible to manufacture the semiconductor device while suppressing the deterioration of the characteristic and the decrease of the yield rate.

In addition, in the explanation of the embodiment of the present invention, the processing recipes and the additional recipes, which are stored in the recipe database 24, are acquired by the processing apparatus. However, the processing recipes and the additional recipes may be stored in an IC card and the like attached to each lot. In accordance with instruction of the recipe designation module 36, the manufacturing apparatus that executes processing of the target process may read out the processing recipe and the additional recipe from the IC card.

(Modification)

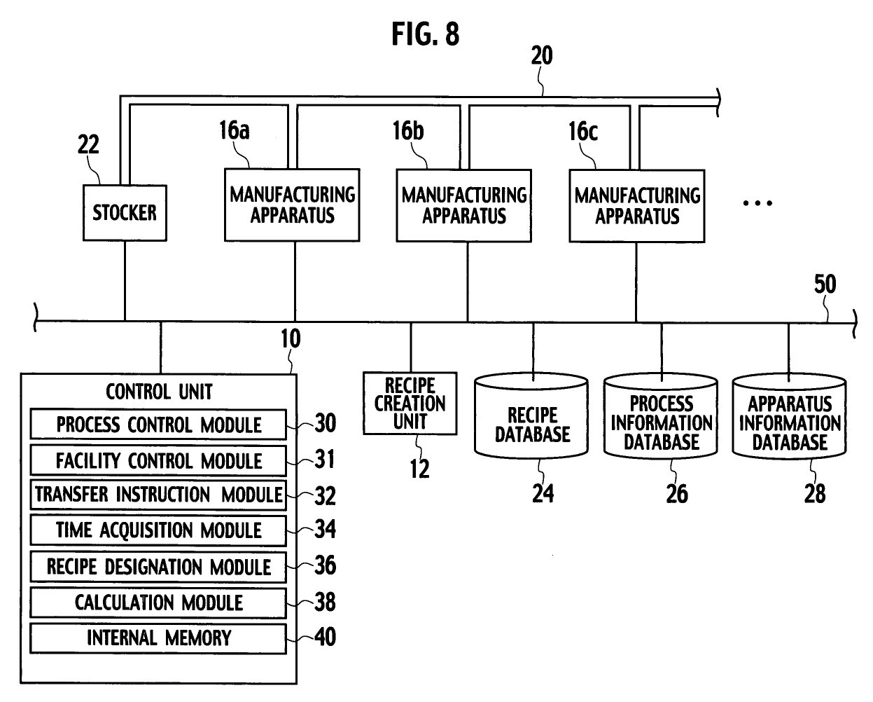

The Production System According to a Modification of the embodiment of the present invention includes a control unit 10a, as shown in FIG. 8. The control unit 10a includes the process control module 30, a facility control module 31, the transfer instruction module 32, the time acquisition module 34, the recipe designation module 36, the calculation module 38 and the internal memory 40 and the like.

The facility control module 31 controls the temperature, humidity, the barometric pressure and the like of an environment, such as a clean room, where the plurality of manufacturing apparatuses 16a, 16b, 16c, . . . , the stocker 22 and the like are installed, and the stocker 22. Also, the facility control module 31 controls concentration, purity and the like of a chemical agent, a source gas and the like supplied to the clean room.

The production system according to the modification of the embodiment of the present invention is different from the embodiment in that the facility control module 31 is installed in the control unit 10a. The other configurations are as in the embodiment. Thus, the duplicated descriptions are omitted.

Progress rates of the physical chemical reaction, adsorption and the like on the surface of the substrate (intermediate product) are different depending on environmental conditions, such as temperature, humidity, barometric pressure and the like of the environment, such as the clean room, the stocker 22 and the like. Therefore, the recipe creation unit 12 creates the additional recipe in consideration of processing conditions with respect to temperature, humidity, and barometric pressure of the environment, to satisfy the production specification of the characteristic and yield rate of the semiconductor device. The recipe designation module 36 designates the additional recipe based on the latency time calculated by the calculation module 38 and the environmental condition acquired by the facility control module 31.

According to the modification of the embodiment of the present invention, even when environmental conditions, which are typically controlled to be held constant, are unexpectedly changed, an additional recipe which responds to the change in the environment condition can be used to execute the manufacturing process. Thus, it is possible to manufacture the semiconductor device with suppressing the deterioration of the characteristic and the decrease of the yield rate.

### Other Embodiments

The present invention has been described as mentioned above. However the descriptions and drawings that constitute a portion of this disclosure should not be perceived as limiting this invention. Various alternative embodiments and operational techniques will become clear to persons skilled in the art from this disclosure.

In the embodiments of the present invention, the electronic device is described as a semiconductor device. However, the electronic device is not limited to a semiconductor device, and may be a liquid crystal display, a magnetic recording medium, an optical recording medium, a thin film magnetic head, a superconductor device, a surface acoustic wave device, and the like.

Various modifications will become possible for those skilled in the art after storing the teachings of the present disclosure without departing from the scope thereof.

What is claimed is:

1. A system for controlling production of electronic devices, comprising:
a recipe creation unit configured to create a processing recipe and an additional recipe, the processing recipe describing processing conditions for first and second processes so as to satisfy a production specification of a characteristic and a yield rate of the electronic devices, the first process executed in a first manufacturing apparatus and the second process executed in a second manufacturing apparatus after the first process, the additional recipe describing additional processing conditions determined based on a relation of the characteristic and the yield rate to a latency time between a completion time of the first process and a start time of the second process so as to satisfy the production specification; and
a recipe designation module configured to designate the additional recipe for processing of intermediate products for the electronic devices, the intermediate products are produced by the first process, when the latency time exceeds a reference.

2. The system of claim 1, wherein the additional recipe includes a processing condition with respect to temperature, humidity, and barometric pressure of an environment of the intermediate products during the latency time, so as to satisfy the production specification.

3. The system of claim 1, wherein the additional recipe is a processing condition of a manufacturing apparatus that is different from the second manufacturing apparatus.

4. The system of claim 1, wherein the additional recipe includes a modification of the processing condition of the second process.

5. The system of claim 1, wherein the additional recipe includes a processing condition that removes a reaction by-product formed on surfaces of the intermediate products in the latency time.

6. The system of claim 1, wherein the additional recipe include a processing condition that removes an adsorbate adsorbed on surfaces of the intermediate products in the latency time.

7. The system of claim 5, wherein the first process is a dry etching process, and the reaction by-product is formed by a reacted gas adsorbed on the surfaces of the intermediate products in the dry etching process.

8. The system of claim 5, wherein the first process is a wet process, and the reaction by-product is a native oxide grown on the surfaces of the intermediate products processed by the wet process after the wet process.

9. A system for producing electronic devices, comprising:
a first manufacturing apparatus configured to execute a first process;
a second manufacturing apparatus scheduled to execute a second process after the first process;
a recipe creation unit configured to create a processing recipe and an additional recipe, the processing recipe describing processing conditions for the first and second processes so as to satisfy a production specification of a characteristic and a yield rate of the electronic devices, the additional recipe describing additional processing conditions determined based on a relation of the characteristic and the yield rate to a latency time between a completion time of the first process and a start time of the second process so as to satisfy the production specification; and
a recipe designation module configured to designate the additional recipe for processing of intermediate products for the electronic devices, the intermediate products are produced by the first process, when the latency time exceeds a reference.

10. A method for producing electronic devices, comprising:
producing intermediate products for the electronic devices by processing with a first manufacturing apparatus based on a first processing recipe, the first processing recipe describing a first processing condition for a first process so as to satisfy a production specification of a characteristic and a yield rate of the electronic devices;
transferring the intermediate products to a second manufacturing apparatus in which a second process is scheduled to be executed after the first process;
acquiring the additional recipe when the latency time exceeds a reference, the additional recipe describing an additional processing condition determined based on a relation of the characteristic and the yield rate to a latency time between a completion time of the first process and a start time of the second process so as to satisfy the production specification; and
processing the intermediate products based on the additional recipe and a second processing recipe, the second processing recipe describing a second processing condition for the second process so as to satisfy the production specification of the characteristic and the yield rate of the electronic devices.

11. The method of claim 10, wherein the additional recipe includes a processing condition with respect to temperature, humidity, and barometric pressure of an environment of the intermediate products during the latency time, so as to satisfy the production specification.

12. The method of claim 10, wherein processing of the additional recipe is executed by a manufacturing apparatus that is different from the second manufacturing apparatus.

13. The method of claim 10, wherein processing of the additional recipe is executed by modifying the processing condition of the second process.

14. The method of claim 10, wherein the additional recipe includes a processing condition that removes a reaction by-product formed on surfaces of the intermediate products in the latency time.

15. The method of claim 10, wherein the additional recipe include a processing condition that removes an adsorbate adsorbed on surfaces of the intermediate products in the latency time.

16. The method of claim 10, wherein, when the second manufacturing apparatus is unusable after the first process, the intermediate products wait in awaiting location until the second manufacturing apparatus becomes usable.

17. The method of claim 14, wherein the first process is a dry etching process, and the reaction by-product is formed by a reacted gas adsorbed on the surfaces of the intermediate products in the dry etching process.

18. The method of claim 14, wherein the first process is a wet process, and the reaction by-product is a native oxide grown on the surfaces of the intermediate products processed by the wet process after the wet process.

19. The method of claim 16, wherein the waiting location is inside a stocker where temperature, humidity, and barometric pressure are controlled.

20. A computer program product configured to be executed by a computer, comprising:
an instruction to create first processing, second processing and an additional recipes, the first and second processing recipes describing processing conditions for first and second processes so as to satisfy a production specification of a characteristic and a yield rate of the electronic devices, the second process executed after the first process, the additional recipe describing additional processing conditions determined based on a relation of the characteristic and the yield rate to a latency time between a completion time of the first process and a start time of the second process so as to satisfy the production specification;
an instruction to drive the first manufacturing apparatus so as to produce intermediate products for the electronic devices by processing with the first manufacturing apparatus based on the first processing recipe;
an instruction to drive the transfer system so as to transfer the intermediate products to the second manufacturing apparatus;
an instruction to acquire the additional recipe when the latency time exceeds a reference; and
an instruction to drive the second manufacturing apparatus so as to process the intermediate products based on the additional recipe and the second processing recipe.
